(19) United States
(12) Patent Application Publication
(10) Pub. No.: US 2013/0135866 A1
(43) Pub. Date: May 30, 2013

(54) HIGH POWERED LIGHT EMITTING DIODE LIGHTING UNIT

(71) Applicants: Francois-Xavier Souvay, Montreal (CA); Yvan Hamel, Laval (CA)

(72) Inventors: Francois-Xavier Souvay, Montreal (CA); Yvan Hamel, Laval (CA)

(73) Assignee: LUMENPULSE LIGHTING INC., Montreal, QC (CA)

(21) Appl. No.: 13/519,777

(22) PCT Filed: Dec. 30, 2010
(86) PCT No.: PCT/CA2010/002064

§ 371 Date: Dec. 13, 2012

Related U.S. Application Data
(60) Provisional application No. 61/291,065, filed on Dec. 30, 2009.
(60) Provisional application No. 61/357,750, filed on Jun. 23, 2010.

(51) Int. Cl. F21V 29/00

(52) U.S. Cl. CPC F21V 29/004
USPC 362/249.02

(57) ABSTRACT

A lighting unit including a thermally conductive array housing for a light emitting diode array mounted on a first surface of a printed circuit board, a heat transfer element located on a second surface of the printed circuit board and forming a thermally conducting path between the array of light emitting diodes and a rear side of the array housing, and a power supply housing spaced apart from the read side of the array housing and including a power supply. Heat dissipating elements on the rear side of the array housing form convective circulation air passages and thermal isolation gaps between the heat dissipation elements and the power supply housing.

### FIELD OF THE INVENTION

The present invention relates to a high power light emitting diode (LED) lighting unit and, in particular, to a high power LED lighting unit for indoor and outdoor lighting functions, such as architectural lighting, having a dynamically programmable single or multiple color array of high power LEDs and improved heat dissipation characteristics.

### BACKGROUND OF THE INVENTION

Developments in LED technology have resulted in the development of “high powered” LEDs having light outputs on the order of, for example, 70 to 80 lumens per watt, so that lighting units comprised of arrays of high powered LEDs have proven practical and suitable for high powered indoor and outdoor lighting functions, such as architectural lighting. Such high powered LED array lighting units have proven advantageous over traditional and conventional lighting device by providing comparable illumination level outputs at significantly lower power consumption. Lighting units comprised of arrays of high powered LEDs are further advantageous in providing simple and flexible control of the color or color temperature of the lighting units. That is, and for example, high powered LED lighting units may be comprised of arrays of selected combinations of red, green and blue LEDs and white LEDs having different color temperatures. The color or color temperature output of such an LED array may then be controlled by dimming control of the LEDs comprising the array, so that the relative illumination level outputs of the individual LEDs in the array combine to provide the desired color or color temperature for the lighting unit output.

A recurring problem with such high powered LED array lighting units, however, is the heat generated by such high powered LED arrays, which often adversely effects the power and control circuitry of the lighting units and the junction temperatures of the LEDs, resulting in shortened use life and an increased failure rate of the power and control circuitry and the LEDs. This problem is compounded by the heat generated by, for example, the LED array power circuitry and is particularly compounded by the desire for LED lighting units that are compact and of esthetically pleasing appearance as such considerations often result in units having poor heat transfer and dissipation characteristics with consequently high interior temperatures and “hot spots” or “hot pockets”.

The present invention provides a solution to these and related problems of the prior art.

### SUMMARY OF THE INVENTION

The present invention is directed to a lighting unit including a thermally conductive array housing including an array of light emitting diodes and light emitting diode control circuits mounted on a first surface of a printed circuit board, and a heat transfer element located on a second surface of the printed circuit board and forming a thermally conducting path between the array of light emitting diodes and a rear side of the array housing, and a power supply housing spaced apart from the read side of the array housing and including a power supply. The array housing includes a plurality of vertically oriented heat dissipation elements located in a space between the array housing and power supply housing and extending toward but not to the front side of power supply housing. The heat dissipating elements, the rear side of the array housing and the front side of the power supply housing form a plurality of convective circulation air passages for the convective dispersal of heat from the heat dissipating elements with thermal isolation gaps between the heat dissipation elements and the power supply housing to thermally isolate the power supply housing from the array housing and light emitting diode array.

The light emitting diode array may include a selected combination of high powered light emitting diodes selected from among at least one of red light emitting diodes, green light emitting diodes, blue light emitting diodes and white light emitting diodes of various color temperatures and the control circuits may include dimming circuits to control a light spectrum and illumination level output of the array of light emitting diode by controlling power levels delivered to the diodes of the light emitting diode array.

The array housing and the power supply housing are mounted to each other by a one or both of a conduit providing a path for power cabling between the power supply housing and the array housing and a plurality of thermally isolating support posts.

In presently preferred embodiments the heat dissipation elements extend in parallel across a width of the array housing as elongated generally rectangular fins having a major width extending across a rear side of the array housing and tapering to a lesser width toward the power supply housing and of a height extending generally from the rear side of the array housing and toward a front side of the power supply housing with a thermally isolating gap between the heat dissipation elements and the front side of the power supply housing.

In presently preferred embodiments the array housing and the power supply housing are each cylindrical in shape with a circular transverse cross section having a diameter greater than the axial length of the housing and a circumferential side wall sloping from a first diameter at the front side of the housing to a lesser second diameter at the rear side housing.

### BRIEF DESCRIPTION OF THE DRAWINGS

The invention will now be described, by way of example, with reference to the accompanying drawings in which:

FIGS. 1A and 1B are back and front perspective views of an LED lighting unit;

FIGS. 2A, 2B and 2C are respectively top, side and front views of an LED lighting unit;

FIGS. 2D and 2E are respectively a diagrammatic view of an LED array of an LED lighting unit and the circuitry of a circuit board for mounting the LEDs of an LED array of a LED lighting unit;

FIG. 2F is a diagrammatic view of a rear surface of the circuit board of FIGS. 2D and 2E; and

FIGS. 3A and 3B are top and side diagrammatic cross sectional views of an LED lighting unit.

### DETAILED DESCRIPTION OF THE INVENTION

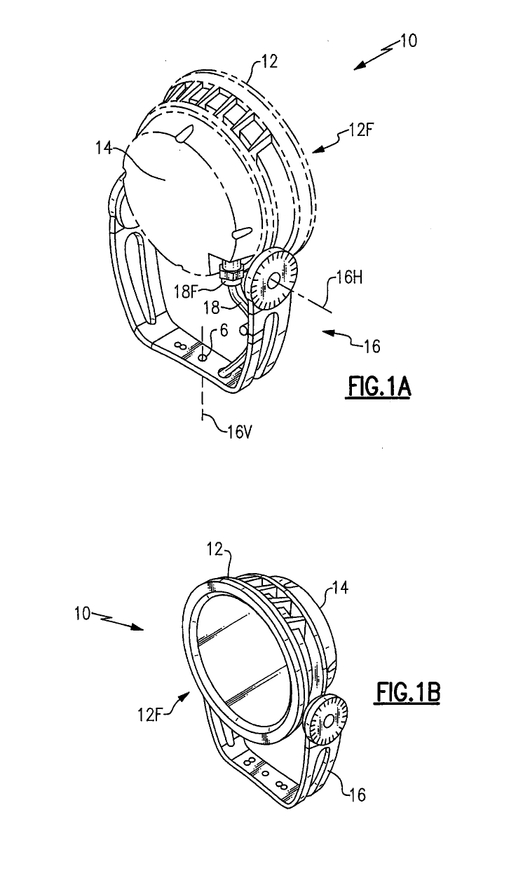

Referring to FIGS. 1A and 1B, therein are shown back and front perspective views of an LED lighting unit 10 of the present invention which, as illustrated, includes an LED array housing 12 which is positioned and oriented at the front of the lighting unit 10 and a power supply housing 14 which is positioned at the rear of the lighting unit 10, behind the LED array housing 12.

In a presently preferred embodiment of a lighting unit 10, array housing 12 and power supply housing 14 are each generally cylindrical in shape, that is, are of generally circular cross section with a diameter greater than their respective heights and/or thicknesses. In the exemplary embodiment considered herein, array housing 12 has a front diameter of approximately 10 inches and tapers to a back side diameter of approximately 9 inches over a thickness of approximately 2 inches while power supply housing 14, which is spaced apart from array housing 12 by approximately ¾ inch has a front diameter of approximately 8 to 8½ inches and tapers to a back side diameter of approximately 8 inches over a thickness of approximately 2 inches. In the present exemplary embodiment, array housing 12 and power supply housing 14 are comprised of cast aluminum having a wall thickness of about 0.25 to 0.30 inches, are provided with a polyester powder coat finish and are sealed according to International Safety Standard IP66.

It will be appreciated and understood, however, that the cross sectional shapes of array housing 12 and power supply housing 14 are generally defined by the shape of the LED array, which is described in detail in a following description, as are the dimensions of array housing 12 and power supply housing 14. It will also be understood that other cross sectional and longitudinal shapes are possible and fall within the scope of the present invention, such as square, rectangular or polygonal for example.

As shown, the lighting unit 10 is typically supported by a conventional mounting bracket 16 which allows vertical rotation of the lighting unit 10 about a horizontal axis 16H which passes through the lighting unit 10 at a point approximately between LED array housing 12 and power supply housing 14, at approximately a center of balance of the lighting unit 10, and the mounting bracket 16 is typically also horizontally rotatable about a vertical axis 16V. It will be understood, however, that a lighting unit 10 of the present invention may be supported or mounted by any of a wide range of other designs of mounting fixtures, including both fixed mounts and positional mounts of various types.

A power/control cable 18 for supplying power and control signals to the LED array may be comprised of separate power and control cables or a single combined power and control cable, enters the lighting unit 10 though a conventional weather tight fitting 18F that, in a present embodiment, is mounted into power supply housing 14. In other embodiments, and in particular embodiments having separate power and control cables, the power cable may enter power supply housing 14 through a power cable fitting 18F while the control cable may enter the LED array housing 12 through a separate control cable fitting 18F.

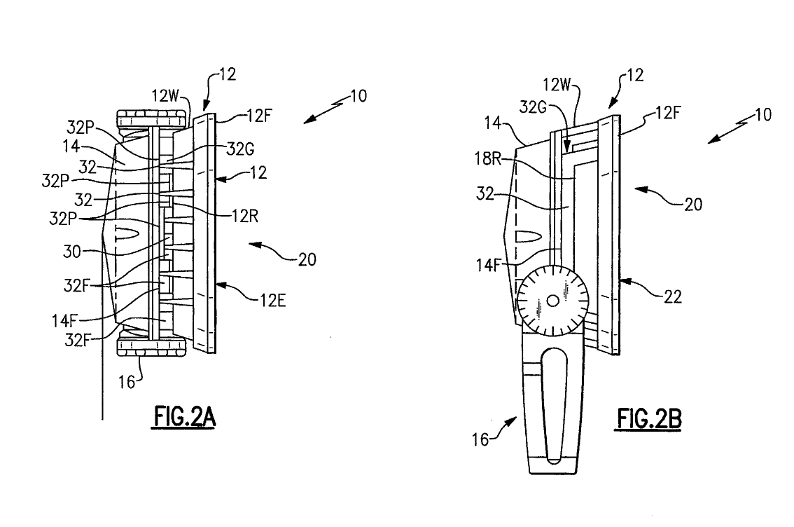

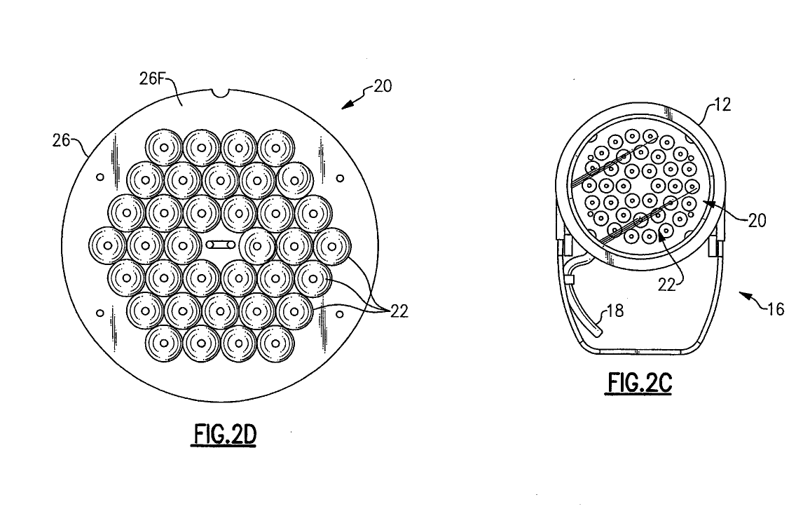

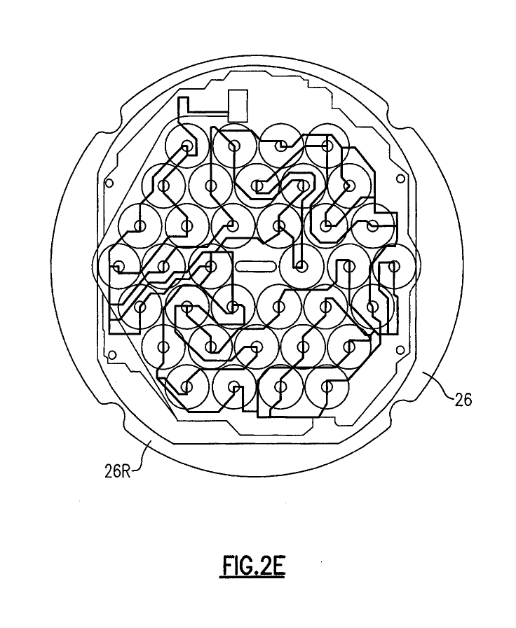

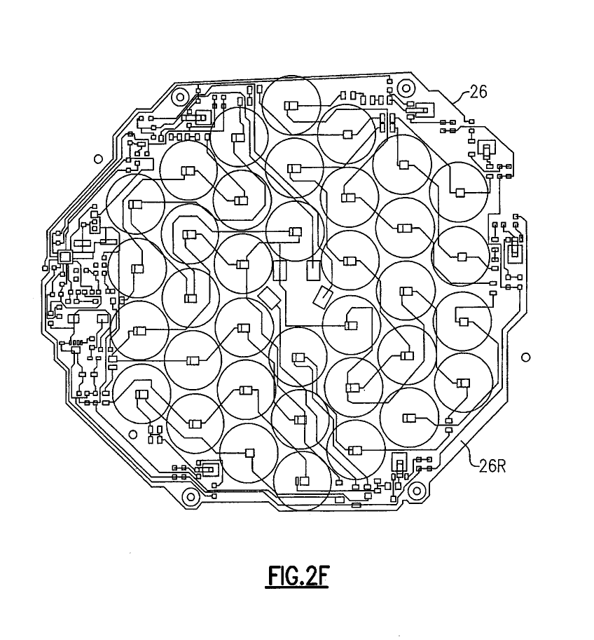

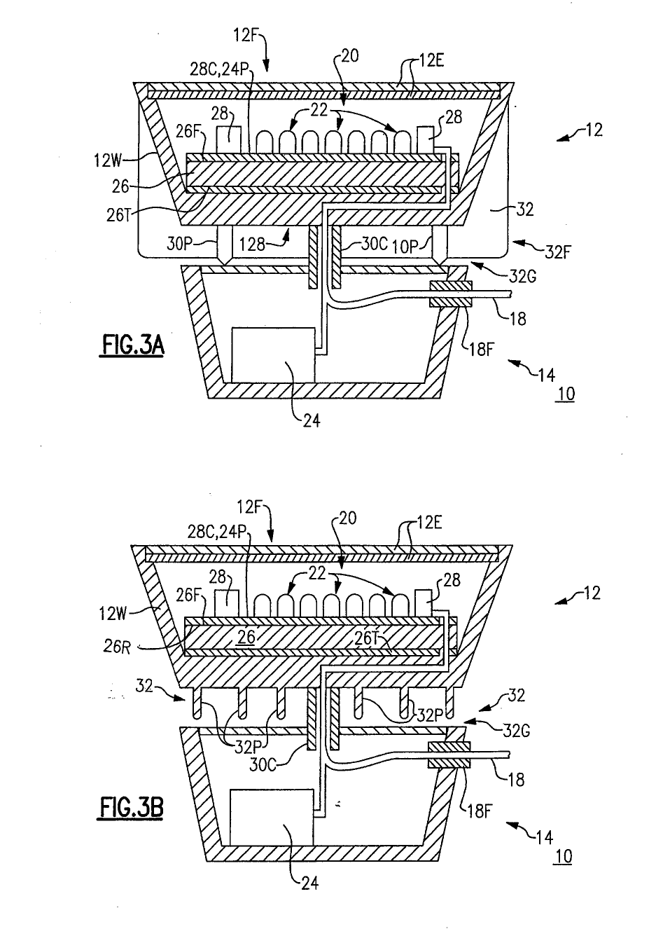

Referring to FIGS. 2A through 2E, FIGS. 2A, 2B and 2C are respectively top, side and front views of an LED lighting unit 10 while FIGS. 2D and 2E diagrammatic view of an LED array and an LED array circuit board while FIGS. 3A and 3B respectively are top and side diagrammatic cross sectional views of an LED lighting unit 10.

As illustrated in FIGS. 2A-2E and FIGS. 3A and 3B and as discussed above, in a present embodiment, the LED array housing 12 is generally cylindrical in shape with a generally circular transverse cross section having a diameter greater than the axial length of the array housing 12 and a circumferential side wall 12W that slopes from a full diameter at the front side 12F of the array housing 12 to a smaller diameter at the rear side 12R of the array housing 12.

As shown in FIGS. 2A-2F, 3A and 3B, the array housing 12 includes an LED array 20 comprised of a symmetric packed array of LEDs 22 for generating and forming a light beam to be generated and transmitted by the lighting unit 10 with LED array 20 being covered and protected by one or more optical/sealing elements 12E. The optical/sealing elements 12E seal the front face 12F of array housing 12 from the external environment, thereby protecting LED array 20 and the other lighting unit components contained within the array housing 12, and may include optical elements for shaping and forming the light beam generated and projected by the LED array 20. Such optical/sealing elements 12E may comprise, for example, beam shaping lenses, optical filters of various types, optical masks or protective transparent cover plates.

The power supply housing 14, in turn, contains a power supply 24 that is connected from the power leads of the power/control cable 18 and supplies power outputs to the LED array 20, as discussed in further detail below.

According to the present invention, the individual LEDs 22 of LED array 20 are mounted on a front side 26F of a printed circuit board 26 that fits and is mounted within the interior compartment defined by the array housing 12. In a present embodiment, the LEDs 22 comprise any desired and selected combination of high powered red, green, blue or white LEDs of various color temperatures, such as 2700° K, 3000° K or 4000° K white light LEDs, depending upon the desired output spectrum or spectrums of the lighting unit 10. In present typical embodiment of a lighting unit 10, the LED array 20 includes, for example, 36 LEDs arranged in a hexagonal array having a diameter of approximately 6 inches and capable of providing approximately 2400 lumens of total illumination at 44 watts power consumption with an output beam having a diameter of approximately 4¾ inches at an radiating angle of between 6° and 30°, that is, between a narrow spotlight beam and a floodlight beam, depending upon the selection and arrangement of LEDs 22 and other optical elements as described below.

It will be appreciated, however, that a lighting unit 10 may be readily constructed with more than or less than 36 LEDs, depending upon the particular application, with any desired combination of LED output colors, and with greater or lessor output power and power consumption by suitable adaptation of the design of the embodiments described herein, as will be readily understood by those of ordinary skill in the relevant art.

As known by those of skill in the relevant art, the color or the color temperature output of an LED array 20 comprised of any desired combination of red, green, blue or white LEDs 22 may be controlled by dimming control of the LEDs 22 comprising the array, so that the relative illumination level outputs of the individual LEDs 22 in the array combine to provide the desired color or color temperature for the lighting unit output. According to the present invention, dimming control of the individual LEDs 22, comprising the LED array 20, is provided by control circuits 28, which are controlled by signals transmitted to each lighting unit 10 through control/power cable 18 according to industry standard protocols, such as and for example, the industry standard DMX512 protocol, the Dali protocol, the digital signal interface (DSI), or the remote device management (ROM) protocol.

As illustrated in FIGS. 2E, 3A and 3B, the control circuits 28 for the LEDs 22 of LED array 20 are also mounted on front side 26F of circuit board 26 and are generally disposed circumferentially about the LED array 20. The control leads 28C connecting control outputs of the control circuits 28 to the LEDs 22 are also formed on a front side 26F of the printed circuit board 26, and the power leads 24P, connecting the power output of power supply 24 in power supply housing 14 to control circuits 26 and LEDs 22, are preferably located on front side 26F of the printed circuit board 26.

According to the present invention, a thermally conductive heat transfer element 26T is, for example, bonded to or formed integrally with back side 26R of printed circuit board 26 of the printed circuit board 26, that is, to or with the side opposite of the printed circuit board 26 opposite LED array 20 and thereby is located in close proximity to the LEDs 22 in order to absorb and carry away generated heat from LEDs 22. In a presently preferred embodiment, the heat transfer element 26T comprises an aluminum plate which extends generally across at least the diameter of the LED array 20. When printed circuit board 26 is mounted into array housing 12, the heat transfer element 26T is thus located in thermally conductive contact with the interior surface of the rear side 12R of the array housing 12 to thereby form a thermally conductive path from the LEDs 22 to the interior surface of the rear side 12R of the array housing 12 thereby to facilitate conducting heat from the LEDs 22 to the rear side 12R of the array housing 12.

Referring next to the assembly of array housing 12 and power supply housing 14, and as illustrated in FIGS. 2A, 2B, 2D, 2E, 2F, 3A and 3B, the array housing 12 is mounted to and supported by the power supply housing 14 by one or more structural members that include at least a cylindrical, tubular conduit structure 30C that extends between the rear side 12R of the array housing 12, that is, the side of the array housing 12 facing toward the power supply housing 14, and the front side 14F of the power supply housing 14 and along the central longitudinal axis 30A of the array housing 12 and the power supply housing 14. In addition to mounting the array housing 12 to the power supply housing 14, the conduit structure 30 comprises a passage between the power supply housing 14 and the array housing 12 for the power leads conducting power from a power supply to the LEDs and the control circuitry of LED array 20 and the control signals from the power/control cable 18 to the control circuitry of LED array 20.

The structural members supporting array housing 12 with respect to power supply housing 14 may further include support posts 30P, which extend between the rear side 12R of array housing 12 and the front side 14F of power supply housing 14 and are located around and spaced apart from conduit structure 30C to maintain an even spacing and transverse alignment between array housing 12 and power supply housing 14. It should be noted that support posts 30P may comprise standoffs connected to one but not both of the array housing 12 and the power supply housing 14 or of elements secured to both the array housing 12 and the power supply housing 14 to mechanically secure the array housing 12 to the power supply housing 14. In the presently preferred embodiments of lighting unit 10, the support posts 30P are formed as standoffs and may be designed to reduce the transfer of heat between the array housing 12 and the power supply housing 14. The support posts 30P may, for example, have reduced diameter ends to reduce the heat transfer capacity of the thermal conduction path through the support posts 30P, or may be provided with or comprised of thermally isolating elements.

As also shown in FIGS. 2A and 2B, the rear side 12R of the array housing 12 is provided with a plurality of vertically oriented heat dissipation elements 32 located in a space between the array housing 12 and the power supply housing 14 and extending in parallel across the width of the array housing 12. In presently preferred embodiments, the heat dissipation elements 32 are generally shaped as elongated rectangular fins having a major width extending across the rear side 12R of array housing 12 and tapering to a smaller width toward power supply housing 14. In the illustrated embodiment of the array housing 12 and the heat dissipation elements 32, the circumferential edges or sides 12S of the array housing 12 are sloped, or beveled, and the heat dissipation elements 32 extend onto and from the sloped sides of the array housing 12 to the outer diameter of the array housing 12, thereby increasing the heat dissipation area of the heat dissipation elements 32.

As illustrated, the heat dissipation elements 32 are of a height extending generally from the rear side 12R of the array housing 12 and toward the front side 14F of the power supply housing 14 but not extending to the front side 14F of the power supply housing 14, thereby forming thermal isolation gaps 32G thermally isolating the power supply housing 14 and the array housing 12 from one another and significantly reducing the transfer of heat between the array housing 12, with LED array 20, and the power supply housing 14, with power supply 24.

It should be noted that thermal conductivity between the heat dissipation elements 32 and the power supply housing 14 may also be reduced while allowing the heat dissipation elements 32 to be in contact with the power supply housing by, for example, minimizing the area of contact between each heat dissipation element 32 and the power supply housing 14 or by interposing a thermal isolation element, such as a thermally non-conductive spacer, between each heat dissipation element 32 and the power supply housing 14.

In addition to providing heat dissipation areas for transferring heat from the array housing 12 to the surrounding air, that is, from LED array 20 to the surrounding air, the heat dissipation elements 32, the rear side 12R of array housing 12 and the forward side 14F of the power supply housing 14 together form a plurality of convective circulation passages 32P for the convective movement of air heated by the heat dissipation elements 32.

The effectiveness and efficiency of this convective heat transfer is, as is well understood by those of skill in the relevant art, a function of the interior dimensions, lengths and number of convective circulation passages 32P, as well as the surface characteristics of the heat dissipation elements 32, the rear side 12R of the array housing 12 and the forward side 14F of the power supply housing 14. For example, the interior dimensions and lengths and the characteristics of the interior surfaces of convective circulation passages 32P determines the type, velocity and volume of convective air flow through convective circulation passages 32P, while the characteristics of the interior surfaces of convective circulation passages 32P is a significant factor in determining the efficiency and rate of heat transfer from the heat dissipation elements 32 to the convective air flow through convective circulation passages 32P.

In the present exemplary embodiment described herein above, for example, having a total of 36 LEDs capable of providing approximately 2400 lumens total illumination at 44 watts power dissipation, the heat dissipation elements 32 have an approximate height of 0.5 inches measured relative to the rear side 12R array housing 12, a width or thickness of approximately 0.25 to 0.30 inch narrowing in the direction away from the rear side 12R with a taper of approximately 6°, and a length ranging from about 8 to 10 inches, depending upon their location across the diameter of the array housing 12, and may be spaced apart by a distance on the order of 1.1 to 1.2 inches. The embodiment under consideration has five enclosed convective circulation passages 32P, that is, passages 32P having a heat dissipation element 32 on each side of the passage 32P, and two one sided convective circulation passages 32P, one on each side of the array housing 12, with each heat dissipation passage 32P having a width of approximately 1 inch, a height of approximately 0.5 inches, and a length ranging from about 8 to 10, depending upon the location of the passage 32P across the diameter of the array housing 12, with the interior surface characteristics of convective circulation passages 32P being determined by the surface textures and the heat transfer characteristics of the cast aluminum and a polyester powder coat finish.

The adaptation of these exemplary dimensions to lighting units 10 having more than or less than 36 LEDs or LEDs with greater or lesser power dissipation levels will be well understood by those of ordinary skill in the relevant art.

The heat dissipation elements 32 thereby provide the maximum heat dissipation area for dissipating heat from LED array 20 while the thermally non-conductive gap between the heat dissipation elements 32 and the power supply housing 14 significantly reduces the transfer of heat between the array housing 12 and the power supply housing 14 and thereby significantly reducing adverse mutual heating effects between the power supply 24 and the LED array 20.

Since certain changes may be made in the above described high power light emitting diode (LED) lighting unit for indoor and outdoor lighting functions, without departing from the spirit and scope of the invention herein involved, it is intended that all of the subject matter of the above description or shown in the accompanying drawings shall be interpreted merely as examples illustrating the inventive concept herein and shall not be construed as limiting the invention.

1. A lighting unit, comprising:
an array housing, including
an array of light emitting diodes mounted on a first surface of a printed circuit board, and
a heat transfer element located on a second surface of the printed circuit board, the heat transfer element forming a thermally conducting path between the array of light emitting diodes and a rear side of the array housing:
a power supply housing spaced a distance away from the rear side of the array housing and including a power supply, the power supply housing being separate from the array housing.

2. The lighting unit of claim 1, wherein:
the array of light emitting diodes includes,
light emitting diodes selected from among at least one of red light emitting diodes, green light emitting diodes, blue light emitting diodes and white light emitting diodes of various color temperatures.

3. The lighting unit of claim 1, wherein:
the array housing and the power supply housing are mounted to each other by a conduit providing a path for power cabling between the power supply housing and the array housing.

4. The lighting unit of claim 1, wherein:
the array housing and the power supply housing are mounted to each other by a plurality of thermally isolating support posts.

5. The lighting unit of claim 10, wherein:
the heat dissipation elements extend in parallel across a width of the array housing as elongated generally rectangular fins having a major width extending across the rear side of the array housing and tapering to a lesser width toward the power supply housing and of a height extending generally from the rear side of the array housing and toward a front side of the power supply housing opposite the rear side of the array housing.

6. The lighting unit of claim 1, wherein:
the array housing and the power supply housing are each cylindrical-like in shape:
the array housing with a circular transverse cross section having a diameter greater than the axial length of the array housing and a circumferential side wall sloping from a first diameter at a front side of the array housing to a lesser second diameter at the rear side of the array housing; and
the power supply housing with a circular transverse cross section having a diameter greater than the axial length of the power supply housing and a circumferential side wall sloping from a first diameter at a front side of the power supply housing to a lesser second diameter at a rear side of the power supply housing.

7. The lighting unit of claim 1 wherein the array housing includes light emitting diode control circuits.

8. The lighting unit of claim 7 wherein the light emitting diode control circuits include dimming circuits for controlling power levels of the array of light emitting diodes to control any one of level of illumination outputted by the array of light emitting diodes, light spectrum outputted by the array of light emitting diodes, and combination thereof

9. The lighting unit of claim 6 wherein:
the circumferential side wall has taper of approximately six degrees.

10. The lighting unit of claim 1 further comprising a plurality of heat dissipation elements extending from the rear side of the array housing toward but not to a side of the power supply housing opposite the rear side of the array housing, and forming thermal isolation gaps between the heat dissipation elements and the power supply housing for thermally isolating the power supply housing from the array housing and array of light emitting diodes.

11. The lighting unit of claim 10, wherein:
the plurality of heat dissipation elements is vertically oriented.

12. The lighting unit of claim 10, wherein:
the plurality of heat dissipation elements is located in a space between the array housing and power supply housing.

13. The lighting unit of claim 10, wherein:
the plurality of heat dissipation elements are cast aluminum with a polyester powder coating.

14. The lighting unit of claim 1 further comprising a plurality of convective circulation air passages for convectively dispersing heat from the heat dissipation elements, the plurality of convective circulation air passages defined by the heat dissipation elements, rear side of the array housing and a side of the power supply housing opposite the rear side of the array housing.

15. The lighting unit of claim 14 wherein the plurality of convective circulation air passages includes five closed convective circulation air passages.

16. The lighting unit of claim 14 wherein each of the plurality of convective circulation air passages has a width of approximately one inch.

17. The lighting unit of claim 14 wherein each of the plurality of convective circulation air passages has a height of approximately 0.5 inch.

18. The lighting unit of claim 14 wherein each of the plurality of convective circulation air passages has a length ranging from approximately 8 to 10 inches depending on the location of a given convective circulation air passage on the array housing.

19. The lighting unit of claim 1 further comprising thermally non-conductive spacers between the plurality of heat dissipation elements and a side of the power supply housing opposite the rear side of the array housing.
